(19) United States
(12) Patent Application Publication
(10) Pub. No.: US 2017/0238465 A1
(43) Pub. Date: Aug. 24, 2017

(54) BLUEBERRY HARVESTER AND METHOD OF HARVESTING

(71) Applicants: Ronald Edward Bodtke, Grand Junction, MI (US); Michael Thomas Bodtke, Grand Junction, MI (US); Daniel Richard Stafford, Grand Junction, MI (US)

(72) Inventors: Ronald Edward Bodtke, Grand Junction, MI (US); Michael Thomas Bodtke, Grand Junction, MI (US); Daniel Richard Stafford, Grand Junction, MI (US)

(21) Appl. No.: 15/279,937

(22) Filed: Sep. 29, 2016

Related U.S. Application Data
(60) Provisional application No. 62/234,343, filed on Sep. 29, 2015.

(51) Int. Cl. A01D 46/253

(52) U.S. Cl. CPC A01D 46/253

(57) ABSTRACT

A fruit harvester (100) includes a conventional engine (108) with gear and throttle assemblies (106) for use in the field to harvest fruit. The harvester (100) includes an air divider assembly with ducting (118), catcher pans and baffles (120). A pivoting picking mechanism (124) is provided, along with a conveyor assembly (126). A separator (138) is provided, with air ducting (146). As fruit passes through the harvester (100), fingers (172, 174) cause the fruit to be removed from the fruit plants and deposited within the harvester (100).

### CROSS-REFERENCE TO RELATED APPLICATIONS

This application claims priority of U.S. Provisional Patent Application Ser. No. 62/234,343, filed on Sep. 29, 2015.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

Field of the Invention

The invention relates to mechanical harvesters for picking blueberries and other soft berries and fruits, and, more particularly, to harvesters employing harvest methods for separating bush during harvest and reducing relative fruit drop damage and fruit loss in the field.

Background Art

The fruit industry in the United States, and particularly the growing and harvesting of blueberries, has experienced relatively explosive growth in the past three decades. At this time, the United States is the largest blueberry producing country in the world. As of 2011, the total yield was approximately 231,000,000 kg. Half of the United States blueberry production in 2011 went to the fresh market, of which the majority was hand harvested.

With the combination of the explosive growth and the continued use of hand harvesting, several problems have plagued the blueberry industry. For example, high labor costs, low harvest efficiency, and relatively poor fresh-market quality of machine-harvested blueberries have been major challenges facing the industry. In this regard, it has been considered that the use of mechanical harvesters over time to replace traditional hand harvesting is a primary key to improving overall efficiency of highbush blueberry production. In this regard, it has been previously reported (as of 1996), that 78% of blueberries harvested by commercial mechanical harvesters had severe bruise damage, compared to 23% for hand harvested blueberries.

In the current commercial climate, it is known in the prior art to employ three somewhat differing mechanisms for detaching ripe blueberries from bushes. One method is known as a “slapper” method. This method uses beater bars which extend from a vertical axis, so as to hit the bushes from both sides simultaneously. A second mechanism is known as the “sway” mechanism. In this type of harvester, the mechanism is similar to a slapper, but swings the beater bars in the same direction so as to move the bushes from side to side. A third mechanism is typically referred to as the “rotary” mechanism. This mechanism consists of horizontal shaking rods extended from a vertical spindle. The rods agitate bushes with vertical or horizontal vibrations.

With respect to known harvesters, one type of harvester was developed by BEI (from South Haven, Mich.) in the mid 1990s. The harvester was known as the “V45,” exhibited some advantages over conventional commercial harvesters, with respect to both blueberry bruise and loss of fruit to the ground. However, the harvester was not widely adopted, in part because its optimal operation occurred at relatively slow groundspeed (less than 1 km/h). Also, the harvester operated best on plants which did not have upright limbs in the middle and had a height of less than 2 meters. Today, blueberry harvesters are known which could be operated at groundspeeds which exceed 1.6 km/h, and capable of harvesting plants which are over 2.2 meters tall, without requiring special plant pruning. Several studies have previously been conducted to compare various potential blueberry mechanical harvesters, with respect to both fruit yield and bruise rate. The studies are set forth in substantial detail in an article authorized by Yu, Li, Takeda, Krewer, Rains and Hamrita; titled “Measurement of Mechanical Impacts Created by Rotary, Slapper, and Sway Blueberry Mechanical Harvesters,” beginning on page 84 of “Computers and Electronics in Agriculture” (Elsevier, 2014).

A number of blueberry harvesters have been the subject of several patents and patent applications. For example, Windemuller, et al, U.S. Pat. No. 5,259,177 issued Nov. 9, 1993, describes a straddle-type blueberry picking machine utilizing an inverted U-shaped frame for passing over a row of crop-bearing bushes. The frame has a longitudinal opening through which the row of crop-bearing bushes pass and into which depend a pair of spaced, freely rotatable picking members. Each picking member is supported from a subframe which is pivotally attached to the mainframe of the harvesting machine. Each subframe is supported on an air bag which can be used to set the initial height of the picking assembly, and which also will tend to isolate vibration from the mainframe of the harvesting machine. A bearing assembly depends from the subframe and supports a housing in which two rotatable eccentric weights are mounted. The weights rotate in a vertical plane, but in opposite directions. Accordingly, the weights pass at the top and bottom of each rotation, and impart a vertical force to the housing. The weights are horizontally spaced from one another, which imparts a horizontal twist to the housing as the weights extend outwardly in opposite directions. An elongated shaft depends from the housing, and supports a series of spaced tiers of elongated fingers which can penetrate deeply into each bush. The sum of the vertical and horizontal forces imparted to each housing by the rotating eccentric weights is imparted to the depending shaft and picking fingers. The picking fingers thereby undergo a complex motion, which enables each picking finger to apply both a vertical and horizontal force to each branch of a bush, so as to allegedly gently harvest the crop.

Burton, U.S. Pat. No. 4,292,792 issued Oct. 6, 1981, describes, as background, the concept that blueberry harvesting machines were known wherein a spoke-carrying shaft was journaled for free rotation and driven in a orbit, so that the spokes would jab in and out of blueberry bushes while they “walked” through the bushes as a result of the free rotation of the shaft. Burton further explains that in the past there was no arrangement for adjusting the orbit of the movement of the spoke-carrying shaft. Accordingly, the blueberry bushes were always subjected to the same amount of spoke thrust, although the speed of orbital movement could be changed.

Burton explains that he has discovered that successful harvesting depends on a combination of speed and magnitude of orbital movement. Accordingly, Burton discloses an adjustable mechanism for the spoke-bearing shaft. The mechanism includes a first shaft for receiving rotary motion, and a second shaft offset from and parallel to the first shaft. Harvesting spokes are mounted in tiers on and projecting regularly from the second shaft. A first screw adjustment is provided for varying the distance between the first and second shafts to vary the orbit of the second shaft. Counter weight members are mounted relative to the second shaft. Second screw adjustments vary the position of the counter weight members to correspond with the adjusted position of the second shaft. In this manner, there is a balance applied to the second shaft in all adjusted positions, with certain of the spokes having their outer ends inclined upwardly relatively to the horizontal, while other spokes have their outer ends inclined downwardly relatively to the horizontal. In this manner, the projection of the outer end of the spokes in a vertical direction provides relatively substantial vertical coverage of the plant being harvested.

Young et al, U.S. Patent Application Publication No. 2014/0250853, published Sep. 11, 2014 is directed to a mechanical blueberry harvester for allegedly maximizing the amount of berries harvested and collected, while minimizing the bruising damage to harvested berries. The harvester includes a framework, collectors, spring elements, pulleys and belts. The collectors are configured to collect berries fallen from branches of the berry bush. Each spring element is connected to the framework in a collector. Each pulley is connected to a spring element and a collector. Each belt has an inner face and an outer face. The inner faces of the belts are in contact with the pulleys. When a trunk of the berry bush comes in contact with a portion of the adjacent belts, the spring elements connected to the portions of the adjacent belts in contact with the trunk are each configured to independently compress and create a gap between the adjacent belts.

Harrett, U.S. Pat. No. 3,187,493, issued Jun. 8, 1965, describes a self-propelled blueberry harvesting vehicle having a bush-straddling self-propelled frame generally shaped as an inverted “U”. Gripping elements are extendable and retractable toward and away from each other from the opposite legs of the vehicle, so as to accommodate the width of the bush base and to press against the base with a selected pressure. The harvester includes oscillating, vibrating or shaking means to oscillate the gripping means on the opposite sides in a synchronous manner and with variable intensity. A flexible, berry-collecting apron is extendable from the opposite legs and is sufficiently flexible to wrap around the base of the bush. Vibrational interference elements are mounted on opposite sides, adjacent the opposite legs, to contact the branch tips and berries, and disrupt the nodal vibrational patterns, so as to thereby cause the berries to be vigorously shaken from the bush.

In one form, the gripping elements are mounted on depending columns affixed to overhead support plates slidable toward and away from each other across the cross member of the inverted U-frame as controlled by a fluid cylinder. Crank and pitmal arrangements on opposing sides are synchronized to oscillate the gripping elements from side to side. In another form, a pair of fluid cylinders on each side support a bracket in an extendable manner. A second pair of fluid cylinders are affixed to the bracket to support the gripping means, so that extension of the first fluid cylinders places the gripping means against the base of the plant, while oscillation of the second fluid cylinders, acting as slaves in response to the master cylinder, vibrate the bush.

Tremblay et al, U.S. Pat. No. 6,105,352, issued Aug. 22, 2000, discloses a harvester having a frame adapter to be driven within a field of berries, with a comb mounted between opposite sides of the frame and comprising a plurality of teeth extending substantially in a horizontal position to seize branches of berries, as the frame is driven in the field. The harvester is provided with a sweeping system mounted on the frame above the comb for sweeping the berries of the branches seized by the comb. The sweeping system comprises a bush parallel to the comb, with a rotatable shaft operably mounted between the opposite sides of the frame. A series of bristles are circumferentially distributed around the shaft.

Robichaud, U.S. Pat. No. 5,369,944, issued Dec. 6, 1994, describes a berry harvester specifically directed to operation on low plants, such as wild blueberries. The apparatus is adapted to mount on a three-point hitch of a farm tractor. The apparatus includes a drum which rotates in a direction against a direction of travel. A series of combs having a series of fingers generally pointed in a directional rotation are mounted at regular angular intervals on the drum. As the apparatus moves over a crop, plants are raked in an ascending movement, thereby retaining the fruits to be harvested. The berries are carried by respective combs on top of the drum, where emptying of each comb is done by gravity. The rotation of the drum and the corresponding advance of the combs is slower than the free rolling of the berries on the backward face of the drum. The fruits then rapidly gain speed to rebound on the back surface of a preceding comb, so as to jump from the surface of the drum and leap over a gap, reaching into an accept chute. As round fruits have negligible coefficients of friction as compared to leaves and debris, the rolling of the berries has the additional effect of separating the fruits from weeds and twigs. The debris remains on the surface of the drum until it is able to fall straight down, thereby avoiding the accept chute.

Gidge, U.S. Pat. No. 5,450,716, issued Sep. 19, 1995, describes a blueberry harvesting machine having a set of channel groups arranged side by side, so as to create a series of picking heads with stripping gaps. The picking heads are connected to a frame. A motive force, such a tractor, moves the frame through a field of plants, and the end of the channels are moved below the crop. The gaps between the channels strip the crop from the plants, and the crop falls into the channel, where the crop may move along the channels, for collecting.

### SUMMARY OF THE INVENTION

In accordance with the invention, a mechanical blueberry harvester is provided which will pick blueberries and other soft berries and fruits, with equal or better quality than exists with respect to hand harvesting. In particular, the mechanical harvesting will produce premium quality berries, with less drop, less field loss, and pre-cooling within the field. In accordance with the invention, picking fingers are provided which vibrate so as to shuck berries off of the blueberry or other bushes. In accordance with one concept of the invention, the fingers are located within a separator, instead of on the outside of the bush, as known in the prior art.

Also in known systems, a gap is typically created when baffles go around the bush during harvesting. This gap is a cause for loss of blueberries. In accordance with further concepts of the invention, air supply hoses are provided having air jets. These air jets and air supply hoses function so as to push the berries to the sides, where the berries are received on conveyors moving longitudinally toward the rear of the harvester.

Further in accordance with the invention, baffles are provided which essentially “hug” the bases of the bushes. In this manner, the berries can essentially roll off of the baffles into the conveyor.

### BRIEF DESCRIPTION OF THE DRAWINGS

The embodiments of the invention will now be described with respect to the drawings, in which:

FIG. 1 is a perspective view of a blueberry harvester in accordance with the invention;

FIG. 2 is a perspective view of a portion of the blueberry harvester shown in FIG. 1, and specifically showing the air duct, fingers, baffles and one of the conveyors;

FIG. 3 is a partial, plan view of a bottom portion of the blueberry harvester shown in FIG. 1, with the harvester approaching a blueberry bush, and with FIG. 3 illustrating the main problem of waste or fruit drop which may be associated with poor baffle coverage around the base of the bush, resulting in approximately 20% loss of the harvest;

FIG. 4 is a partial, plan view, similar to FIG. 3, but showing the harvester engaged with and wrapped around the blueberry bush, again illustrating a problem of fruit drop associated with poor baffle coverage around the base of the bush, resulting in 20% loss of the harvest;

FIG. 5 is a partial elevation view of a first embodiment of the harvester shown in FIG. 1, and showing the air ducting through which air is applied and blown toward the sides of the bush being bisected by the harvester;

FIG. 6 is a further view of the air assembly of the harvester shown in FIG. 1, showing the relative position of the air ducting, fingers, inner sway assembly, and bush separator, in addition to an air divider for separating the air flows within the harvester;

FIG. 7 is a partial, plan view of the interior of the harvester, showing the relative movement of the fingers, and the movement of the center picking mechanism, movement of the outer picking mechanism and the tie bars connecting the picking mechanism to a cam plate and hydraulic motor;

FIG. 8 is a partial elevation view showing a bush separated by the harvester and further showing the inner sway bar assembly, the outer sway bar assembly and the outer sway bar pivot;

FIG. 9 is a partial perspective view of a second embodiment of the blueberry harvester shown in FIG. 1, showing the cam plates which drive the outer sway assembly, inner cam plates that drive the inner sway assembly, hydraulic motors, air ducts, bush separator/dividers in the form of a rib cage, outer sway bar pivot frame, and outer sway bar pivot cylinder and cylinder anchor point;

FIG. 10 is a side elevation view of the second embodiment of the blueberry harvester shown in FIG. 1, showing the front separator bar/divider, center tie bar for the cam plate to center the sway assembly drive, the air duct and air frame assembly, as well as the bush separator rib cage;

FIG. 11 is a plan view of the second embodiment of the blueberry harvester, showing the bush separator, connection to air ducting, outer sway assembly and a cam plate;

FIG. 12 is a front elevation view of the second embodiment of the blueberry harvester, showing the blower, air ducting and bush separator or rib cage;

FIG. 13 is a front elevation view of the second embodiment of the blueberry harvester shown in FIG. 1, with the outside finger brackets in a tilted configuration;

FIG. 14 is a front elevation view of the first embodiment of the blueberry harvester shown in FIG. 1, with the outside finger brackets in a tilted configuration;

FIG. 15 is a front elevation view of a portion of the blueberry harvester shown in FIG. 1, in a first embodiment, and showing the relative positioning of the cam plates with the outside finger brackets in a tilted configuration; and

FIG. 16 is a perspective view of a blueberry harvester similar to that shown in FIG. 1, but showing the use of an air conditioned canopy over the driver's cockpit, which can be extended downwardly so as to provide for air conditioning throughout the entirety of the blueberry harvester.

### DETAILED DESCRIPTION OF THE INVENTION

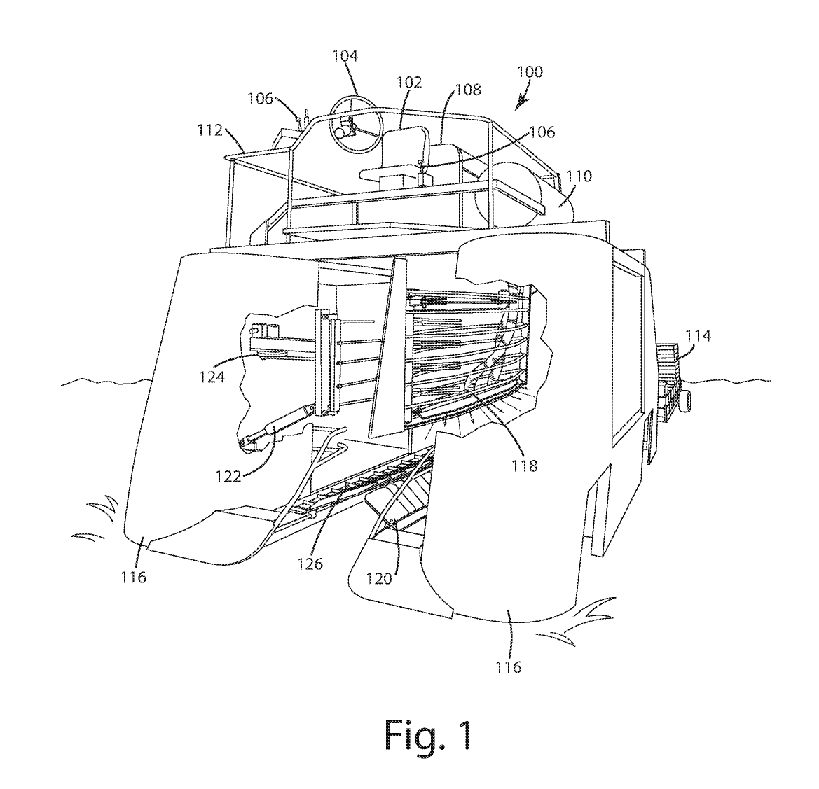

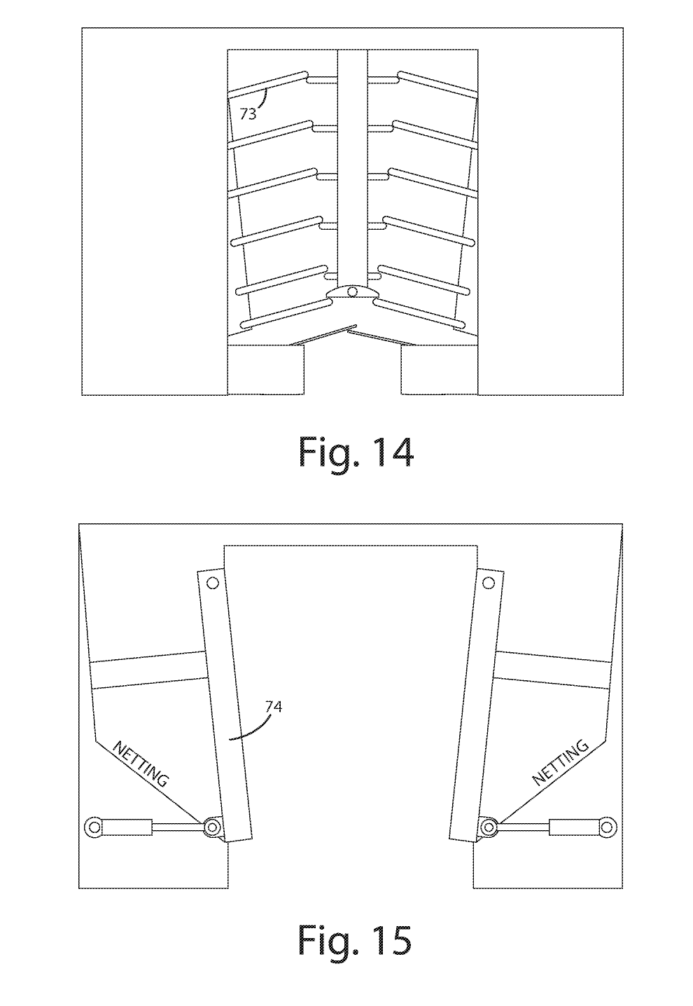

The invention will now be described, by way of example, with a pair of embodiments of blueberry harvesters, as described in subsequent paragraphs herein, and as illustrated in FIGS. 1-16. In accordance with a number of concepts of the invention, the blueberry harvester uses a separator to separate the branches of the berry bush during the picking operation. Picking fingers vibrate so as to shuck berries off of the bush. In accordance with one concept of the invention, the fingers are located with the separator assembly, and not the outer sides of the bush. In accordance with a further aspect of the invention, an air assembly is provided so that air jets which can be made adjustable will blow air during the picking operation, so as to increase the relative percentage of berries which are received on baffles and then deposited onto conveyors. The baffles of the harvester are utilized to “hug” the bases of the bushes. In this manner, the berries can roll onto the baffles and then further roll onto the conveyors. With the use of the air assembly, the fruit drop is substantially lessened, compared to known systems. In accordance with other concepts of the invention, pre-cooling of fruit on the harvester can also be provided. This is achieved through the use of cooling systems which can be located at the base of the harvester. Alternatively, an entire air conditioning canopy can be positioned over the cockpit of the harvester and draped down to the lower portions of the harvester. In this manner, the entirety of the harvester is maintained in a cooled state. In accordance with further concepts of the invention, the harvester in accordance with the invention can operate 24/7 weather permitting. Further, testing has shown that harvesting volume can be achieved in the range of 40,000 kg per 24 hours. Costs which can be saved as a result of the use of a harvester in accordance with the invention include the cost of hand harvesting, dropped fruit, or field loss fruit. Further, higher quality fruit is delivered to the packing facility by pre-cooling. This provides for a longer shelf life.

Again, with harvesters in accordance with the invention, the bushes are separated for purposes of the harvesting, in a similar manner as to how hand pickers achieve harvesting. An air assembly is provided to reduce fruit drop damage, and air and catch pans can be utilized to reduce fruit loss in the field. Further, pre-cooling of fruit can be achieved on the harvester, through various types of cooling assemblies in accordance with the invention.

The harvesters in accordance with the invention provide for a relatively softer touch harvesting, so quality is similar to hand harvest. However, with harvesters in accordance with the invention, the fruit is never touched by human hands. Further, the lowering of the variant temperature in the field and on the harvester promotes relatively better quality for the fruit. In addition, new pruning of plants for a more open center will allow for better sunlight, and for more even ripening of fruit. The open center of the bush also provides for better pest, disease and chemical control. The drop loss is relatively less than the drop loss from hand harvesting.

Turning to the drawings, and particularly with respect to FIG. 1, a blueberry harvester 100 is illustrated in perspective view. The harvester includes a number of conventional items, such as a driver's seat 102 positioned at the top of the harvester, with a steering assembly for the driver. Gear and throttle assemblies 106 are located so as to be accessable to the driver, and can be utilized to operate not only the gearing and throttle control, but also control of various other systems and assemblies on the harvester 100. The harvester can include a conventional engine 108, with a hydraulic tank 110. A guard rail 112 surrounds the cockpit area of the driver seat 102.

For purposes of receiving and stacking blueberries as they are picked by the harvester 100, a tote trailer 114 can be trailered behind the harvester, for purposes of storing blueberries, empty pallets and the like.

The blueberry harvester 100 can include a conventional front frame or nose cones 116. An air divider assembly with ducting 118 is provided within the interior of the harvester 100. Catcher pans or scales 120 can be positioned at the lower portion of the harvester. For operation of the various mechanisms of the harvester 100, air cylinders are provided throughout the harvester, such as cylinder 122 shown in FIG. 1. The cylinder 122 and other similar elements can be used to control a pivoting outer picking mechanism 124 illustrated in FIG. 1. When berries are picked through the use of the various picking mechanisms, the berries are received on a conveyor assembly 126, after dropping onto the baffles 120.

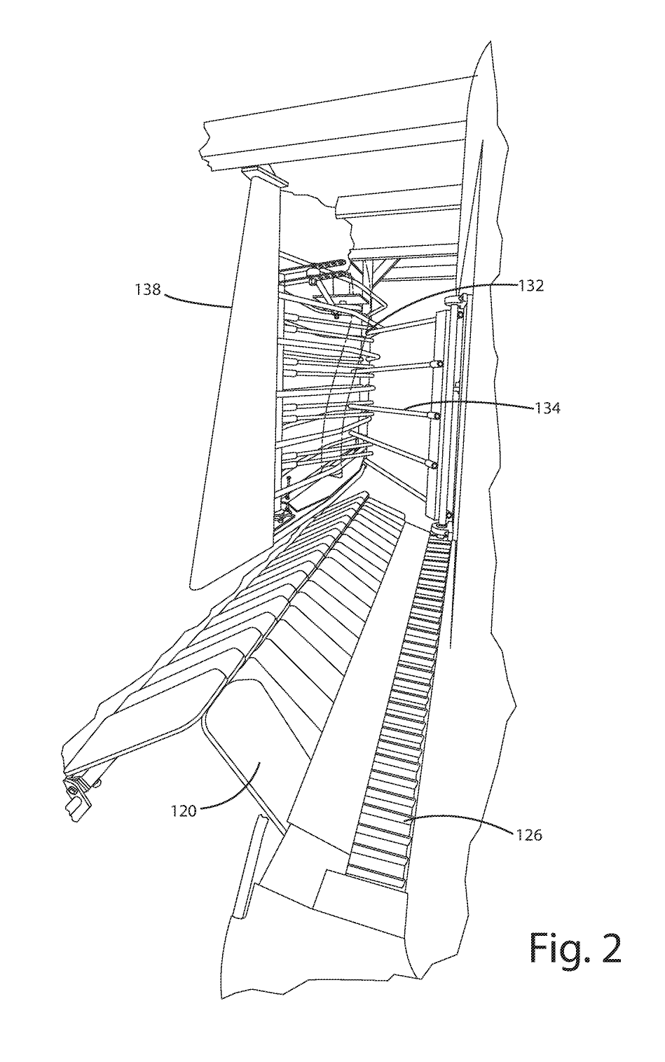

Turning to FIG. 2, the FIG. illustrates a number of elements of the lower portion of the harvester 100. Specifically, the baffles 120 are shown, with one of the conveyors 126. Also shown is the separator 138 which separates or bisects the bush 140.

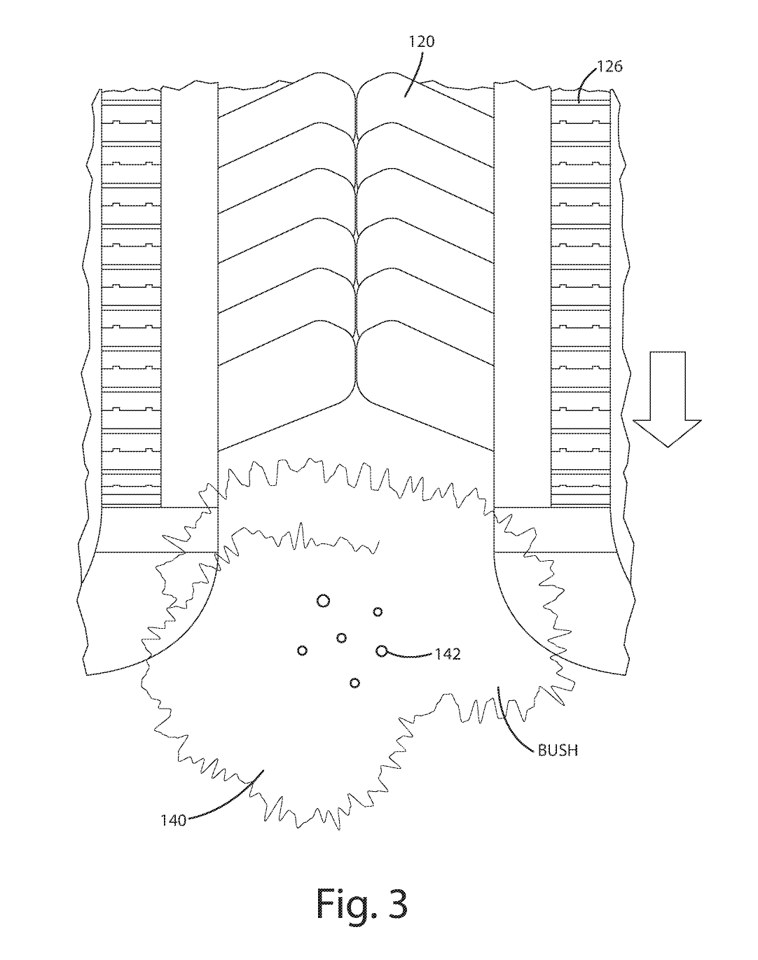

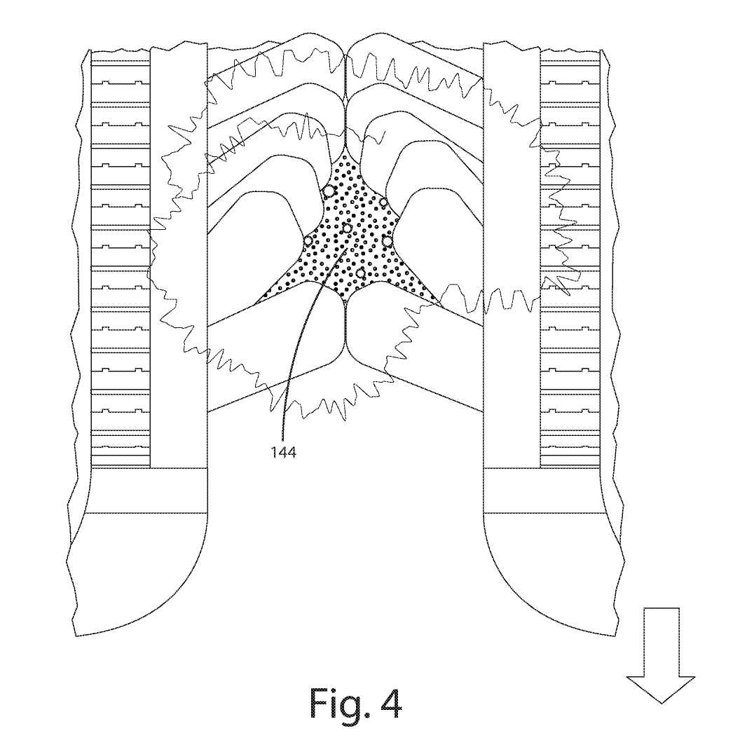

As shown in FIG. 3, the harvester 100 is shown as the bush 140 is entering the central portion and interior of the harvester 100. The berries are illustrated as berries 142. If there is relatively poor baffle coverage around the base of the bush, drop loss can exceed 20%. This is illustrated in FIG. 4, where the harvester 100 is shown as being wrapped around the bush 140. The fruit drop is illustrated as drop loss. As shown in FIG. 4, the baffles 120 are closed between bushes, but then allowed to rotate and open around the crew of the bush.

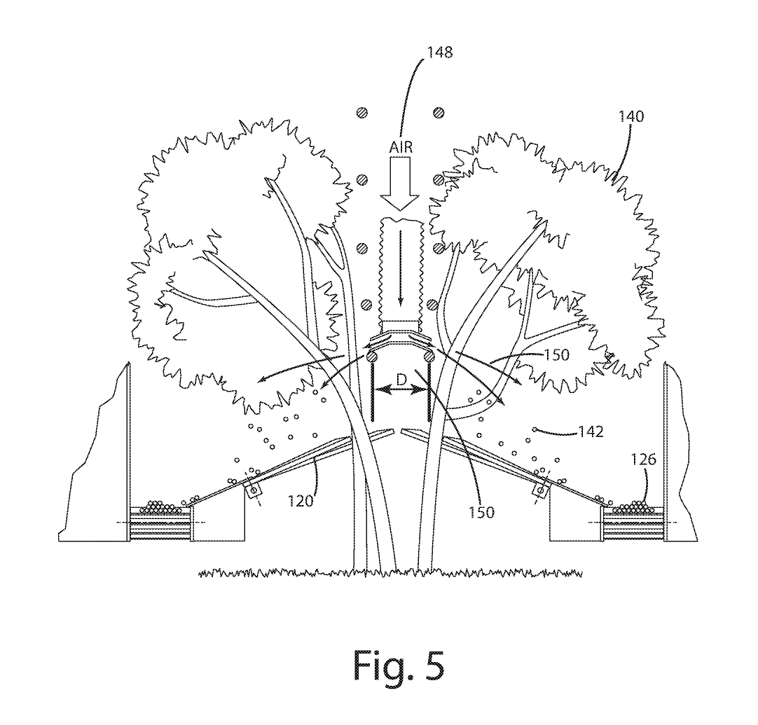

As illustrated in FIG. 5, the air ducting 146 receives air from an air supply 148 which may be any of a number of conventional and commercially available air supplies. The air is supplied through a series of adjustable air nozzles 150. The air nozzles 150 divert the air from the air ducting to the sides of the interior of the harvester. This will cause the berries to be blown to the sides and received on the baffles 120. The berries 142 will then drop onto the conveyor assemblies 126.

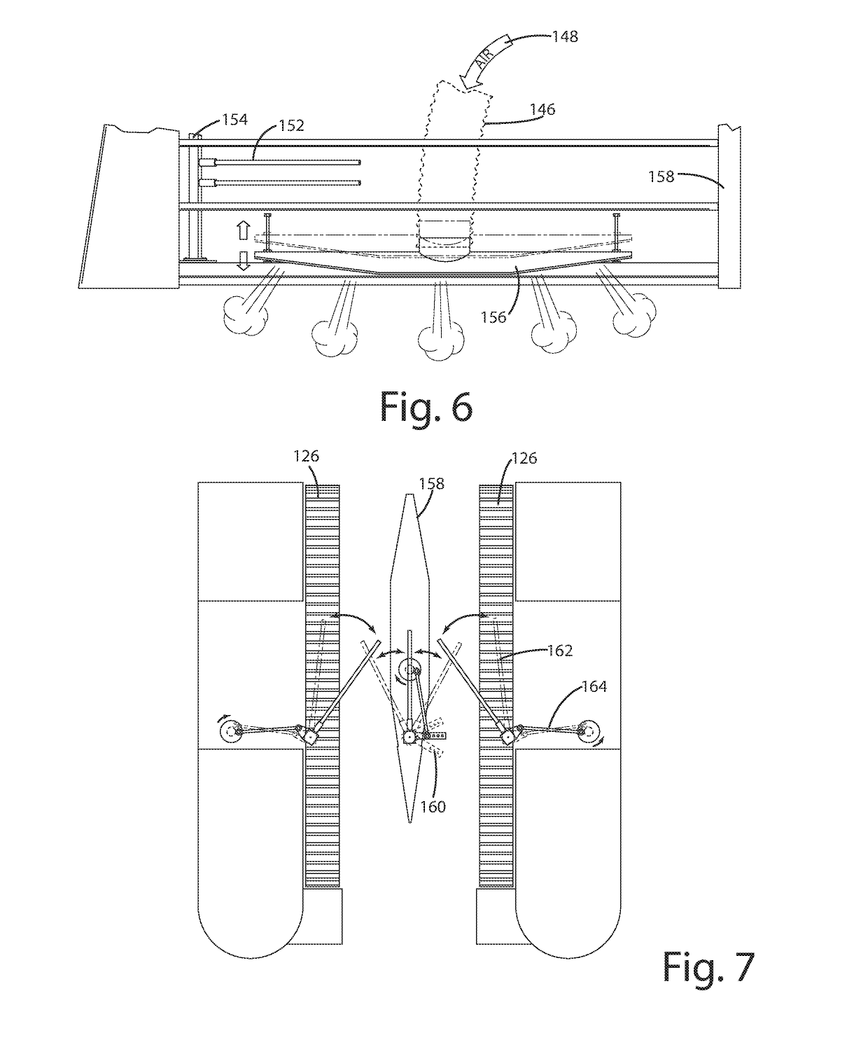

As shown in FIG. 5, with the bush 140 separated, adjustable air nozzles 150 operate so as to selectively apply air streams at appropriate locations so as to facilitate the berries 142 falling on the baffles 120 and the conveyors 126. As shown in FIG. 6, the air ducting 146 is provided with air through an air supply 148. Inner sway fingers 142 are shown in extended position, under control of the sway bar 154. The adjustable air nozzles 150 are controlled through the air dividers 156. The bush separator 158 is used for separating the branches of the bush 140.

With respect to FIG. 7, the conveyors 126 are shown, with the bush separator 158 positioned therebetween. FIG. 7 also shows the relative movement 160 of the inner picking mechanism. Correspondingly, FIG. 7 also shows the movement 162 of the outer picking mechanism. Element 164 is a tie bar for the picking mechanism, and is tied to a cam plate and hydraulic motor.

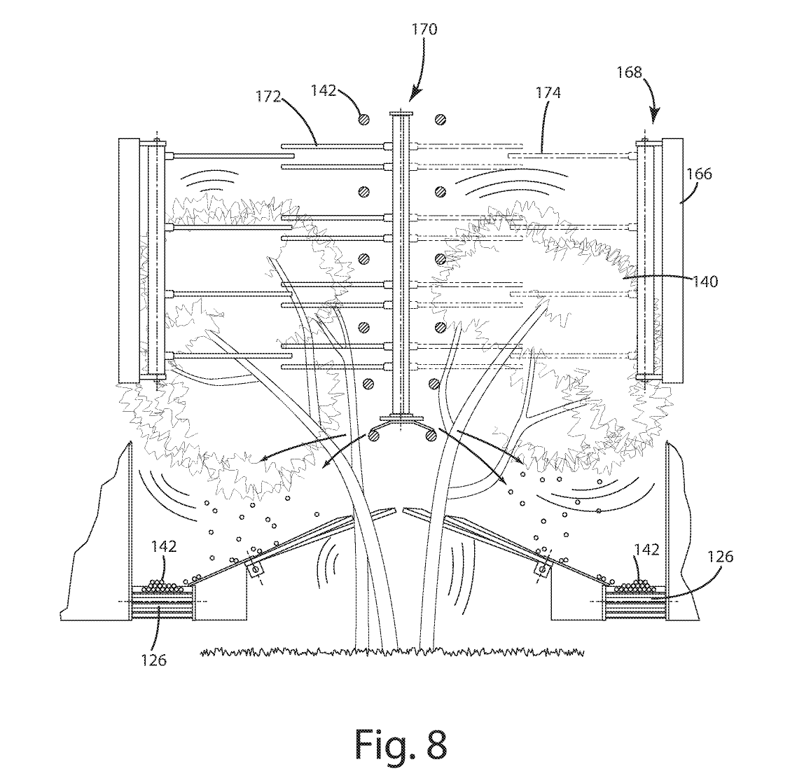

Turning to FIG. 8, an inner sway bar assembly 170 is shown, along with an outer sway bar pivot frame 166 and outer sway bar assembly 168. Inner fingers 172 are also provided, as well as outer fingers 174. FIG. 7 also shows the bush 140, blueberries 142, and conveyors 126.

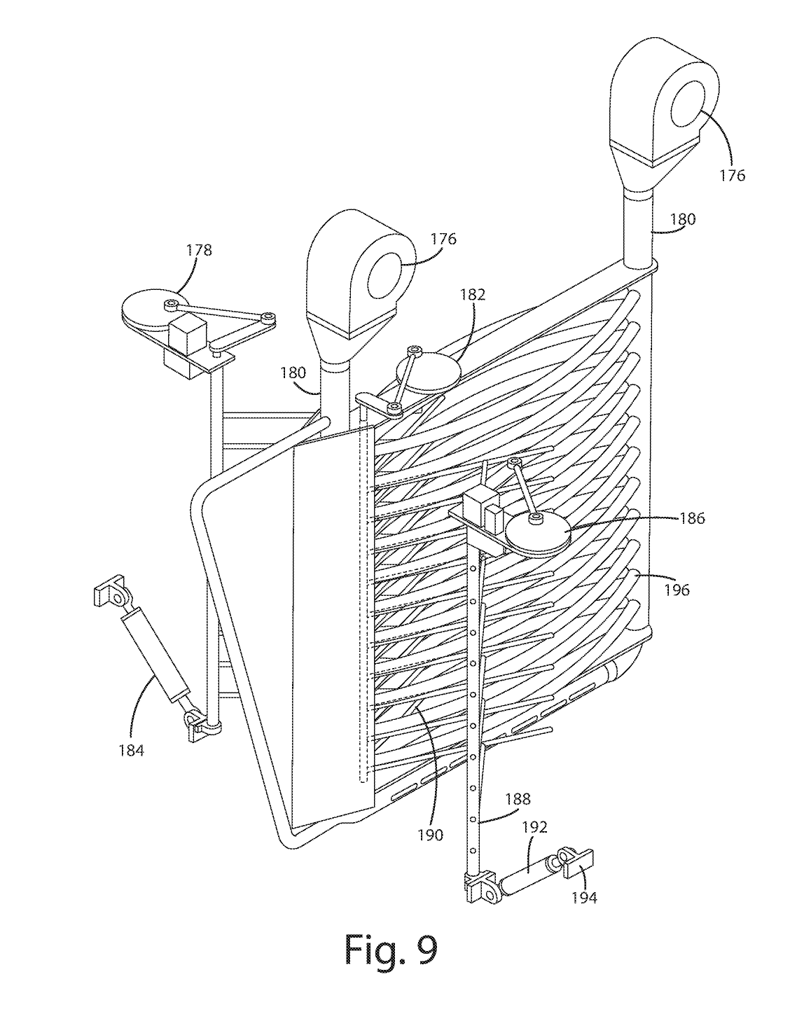

FIG. 9 is a perspective of a second embodiment of a blueberry harvester in accordance with the invention. FIG. 9 illustrates blow motors 176. The blow motors 176 will supply air through the air ducting and framework 180. Also shown are cam plates 178 that drive the outer sway assembly. In addition, inner cam plates 182 are utilized to drive the inner sway assembly. Element 184 is similar to element 192, and comprises an outer sway bar pivot cylinder. Element 194 is a cylinder anchor point. Element 186 corresponds to element 178 and comprises a cam plate that drives the outer sway assembly. Element 188 consists of an outer sway bar pivot frame. Element 190 corresponds to the inner sway bar assembly. Correspondingly, element 196 provides for a bush separator/divider rib cage.

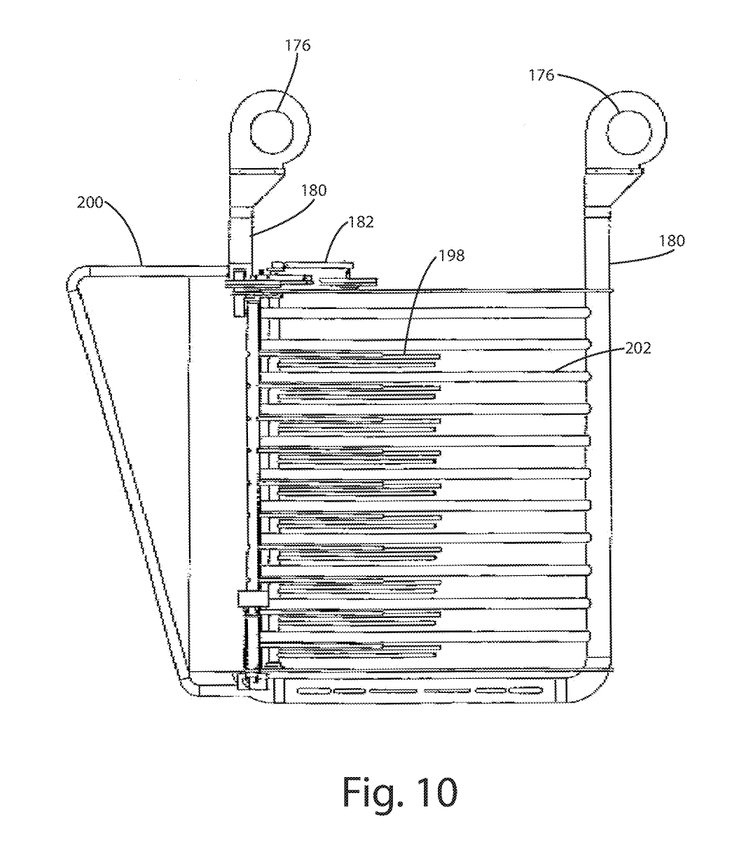

Turning to FIG. 10, the figure shows a side elevation of the second embodiment of the invention. Specifically, element 198 corresponds to the inner sway bar assembly, while element 200 comprises the front separator bar/divider. Element 202 comprises the bush separator/rib cage.

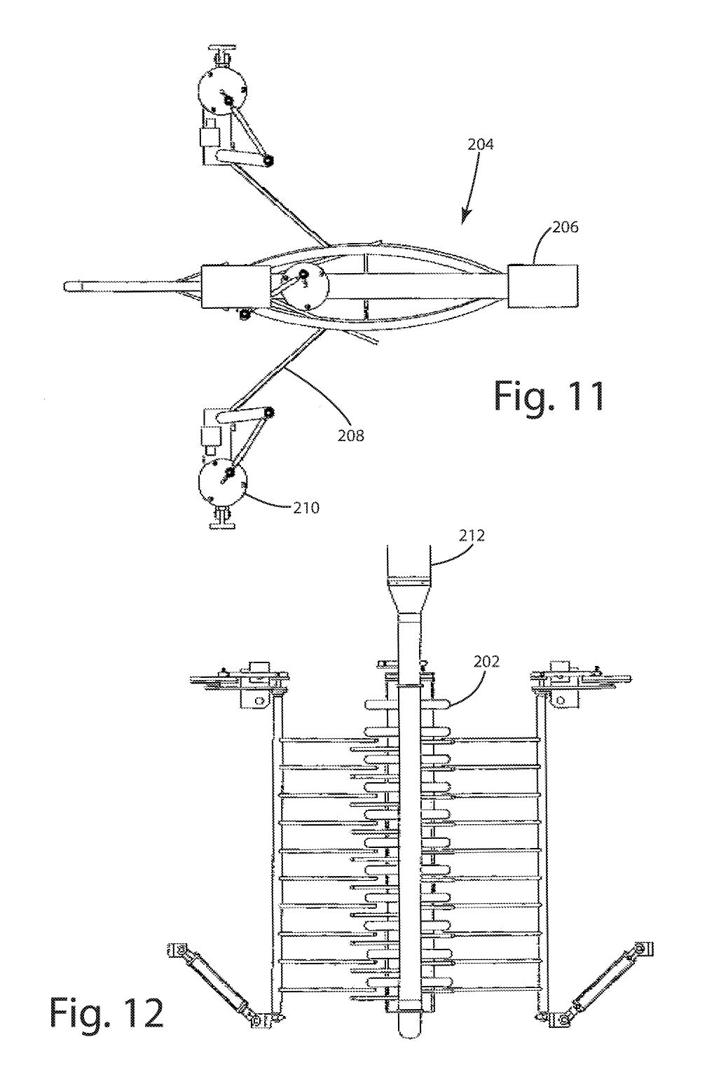

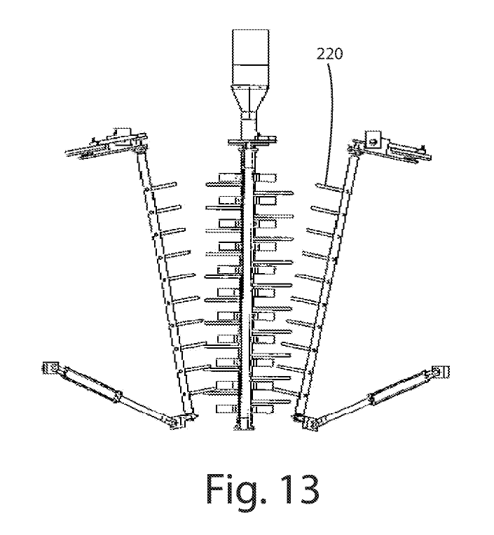

FIGS. 11 and 12 illustrate top and front elevation views of the second embodiment. Specifically, FIG. 11 shows a bush separator 204, with air ducting 206, and outer sway assembly 208, and cam plate 210. Correspondingly, FIG. 12 illustrates some of the same elements, but also shows element 202 which is the bush separator or rib cage, and element 212 is a blower. In accordance with certain concepts of the invention, FIGS. 13, 14 and 15 illustrate views with the outside finger brackets being in a tilted or angled configuration. This tilted configuration can facilitate the blueberry harvesting.

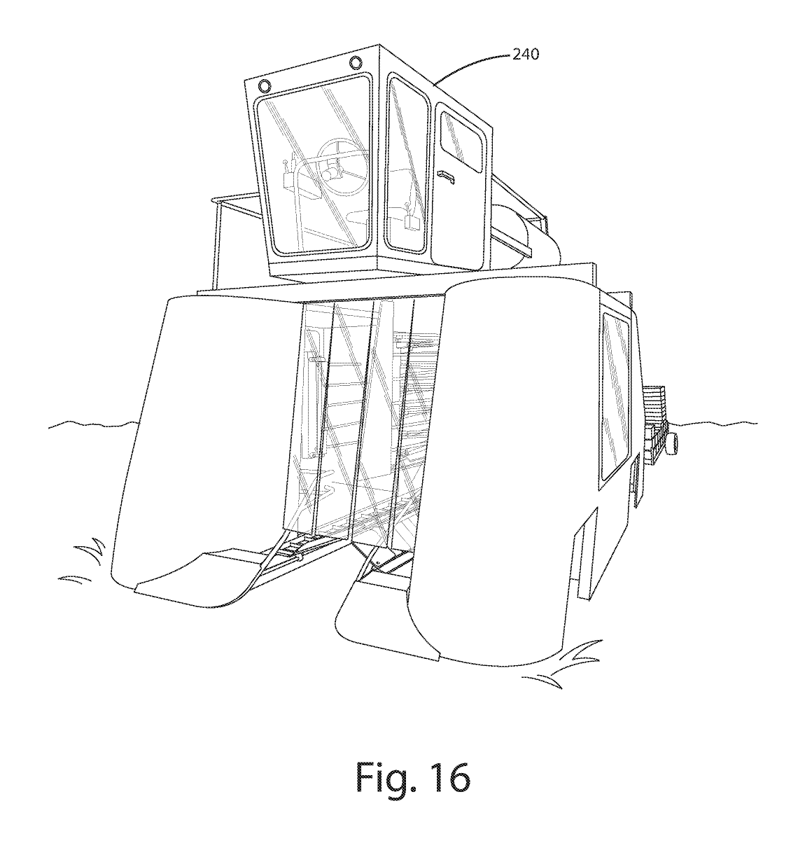

Still further, cooling systems can be applied to the harvester 100 so as to provide for a cooling of the blueberries 142. The cooling can be provided by having commercially available coolers positioned adjacent the conveyors so as to cool the blueberries immediately after they have been harvested. As another alternative embodiment, FIG. 16 illustrates the use of an enclosed canopy 240 which can surround the driver cockpit and have an air conditioning system. To provide cooling for the blueberries, the canopy 240 can be modified so as to be draped around the entire lower portion of the blueberry harvester 100, so as to enclose the area where the blueberries are being harvested and moved along the conveyor system.

It will be apparent to those skilled in the pertinent arts that other embodiments of the blueberry harvesters in accordance with the invention can be designed. That is, the principles of the blueberry harvesters in accordance with the invention are not limited to the specific embodiments described herein. Accordingly, it will be apparent to those skilled in the art that modifications and other variations of the above-described illustrative embodiments of the invention may be effected without departing from the spirit and scope of the novel concept of the invention.

1. An over-the-row fruit harvester adapted to operate in a field so as to catch fruit harvested by said fruit harvester from rows of fruit plants, said fruit harvester comprising:
a movable chassis frame for traversing said rows of fruit plants for harvesting said fruit therefrom;
a centralized tunnel formed through an opening of said chassis frame, and extending longitudinally from a front of said chassis frame to a rear of said chassis frame, said fruit plants moving through said centralized tunnel as said fruit is harvested therefrom;
a picking mechanism positioned within said chassis frame and adapted to sequentially contact said fruit plants, so as to cause said fruit to be physically removed and dropped from said fruit plants, said picking mechanism comprises:
a separator for separating branches of said fruit plants during said picking operation;
picking fingers which operate so as to vibrate and shuck fruit off of said fruit plants, said picking fingers being located within said separator assembly, and not located so as to abut or otherwise pass through outer sides of said fruit plant.

2. A fruit harvester in accordance with claim 1, characterized in that:
said fruit harvester further comprises at least one separator having a set of baffles;
said separator further comprises an air assembly having air jets which are adjustable in position and volumetric air flow, and cause high volume air to impact said fruit plants during said picking operation, wherein a relative percentage of fruit which are received on said baffles and then deposited onto conveyors is increased.

3. A fruit harvester in accordance with claim 2, characterized in that:
with said use of said air assembly, fruit drop is substantially lessened;
said baffles of said fruit harvester are utilized to hug bases of said fruit plants, wherein said fruit can roll onto said baffles and then further roll onto conveyors.

4. A fruit harvester in accordance with claim 1, characterized in that said harvester comprises pre-cooling means for pre-cooling of fruit on said harvester as said fruit is being picked from said fruit plants.

5. A fruit harvester in accordance with claim 4, characterized in that said pre-cooling system can comprise an entire air-conditioning canopy which is positioned over a cockpit of said fruit harvester and draped down to lower portions of said harvester, thereby maintaining a cooling space throughout said fruit harvester, and also facilitate use of said harvester during poor weather conditions.

6. A fruit harvester in accordance with claim 1, characterized in that said harvester provides for a relatively softer touch harvesting, similar to that which is achieved through hand harvesting.

7. A fruit harvester in accordance with claim 6, characterized in that said harvested fruit is never touched by human hands during said picking process.

8. A fruit harvester in accordance with claim 1, characterized in that said picking mechanism comprises a separator having fingers therein, with said fingers being located within said separator and not on the outside of said fruit plants.

9. A fruit harvester in accordance with claim 1, characterized in that said harvester comprises a set of baffles which are positioned around said fruit plant during harvesting, and air supply hoses having air jets which function so as to cause high speed air to impact said harvested fruit and push said harvested fruit to the sides, where said fruit can be received on conveyors moving longitudinally toward said rear of said harvester.

10. A fruit harvester in accordance with claim 1, characterized in that said harvester comprises baffles which hug bases of said fruit plants.

11. A fruit harvester in accordance with claim 1, characterized in that said harvester is self-propelled.

12. A fruit harvester in accordance with claim 1, characterized in that said harvester is passively driven.

13. A fruit harvester in accordance with claim 1, characterized in that said tunnel comprises a pair of opposing lateral sides.

14. A fruit harvester in accordance with claim 1, characterized in that said picking mechanism is located in a longitudinal center of said tunnel.

15. A fruit harvester in accordance with claim 1, characterized in that said harvester further comprises a conveyor system positioned in said tunnel and adapted to receive fruit caught by said catcher plates.
